(19) United States
(12) Patent Application Publication
(10) Pub. No.: US 2025/0291928 A1
(43) Pub. Date: Sep. 18, 2025

(54) THREAT MODELING AT SCALE

(71) Applicant: Wells Fargo Bank, N.A., San Francisco, CA (US)

(72) Inventor: Preeti Santhanam Iyer, Gilbert, AZ (US)

(21) Appl. No.: 18/604,008

(22) Filed: Mar. 13, 2024

(51) Int. Cl. G06F 21/57

(52) U.S. Cl. CPC G06F 21/577; G06F 2221/033

(57) ABSTRACT

A computer system and method for managing security vulnerabilities in software development, including initializing a review process during application workload development, including scanning of application workload components to detect security vulnerabilities, and assessing a likelihood of the identified vulnerabilities being false positives through an analysis involving their characteristics and historical data on similar issues. Based on the review process, the system can retrieve precedent decisions on similar vulnerabilities from a historical database, and determine an automated disposition action for each identified vulnerability, streamlining the vulnerability management process within the software development lifecycle.

### BACKGROUND

In the rapidly evolving landscape of software development, managing security vulnerabilities has become a paramount concern. As applications grow in complexity and scale, the potential for security breaches escalates, posing significant risks to data integrity, user privacy, and overall system reliability. Traditionally, the process of identifying and addressing these vulnerabilities has been largely manual, involving periodic reviews and audits conducted by security experts. This approach, while thorough, is time-consuming and prone to human error, leading to potential oversights and delays in vulnerability management. Moreover, the reactive nature of such methods, typically applied late in the development cycle, often results in costly and disruptive remediation efforts, undermining the efficiency of development workflows and the timely delivery of secure software products.

The current methodologies for vulnerability management also struggle with the challenge of false positives, where benign aspects of the code are mistakenly flagged as vulnerabilities. This not only diverts valuable resources but also dilutes the focus on genuine threats, thereby compromising the effectiveness of security measures. Furthermore, the reliance on expert knowledge and manual intervention limits the scalability of security practices, making them less adaptable to the dynamic demands of modern software development environments.

### SUMMARY

Embodiments of the disclosure are directed to managing security vulnerabilities in software development, including initiating a review process for an application workload during development, wherein the review process includes scanning one or more components of the application workload, identifying a security vulnerability based on the review process, predicting a probability that the security vulnerability is a false positive based on an analysis of one or more characteristics of the security vulnerability and historical data pertaining to one or more similar security vulnerabilities, identifying one or more precedent decisions related to a disposition of the one or more similar security vulnerabilities, wherein the one or more precedent decisions are retrieved from a database containing historical responses to security vulnerabilities, and determining whether to apply an automated disposition action for the security vulnerability based on the one or more precedent decisions and the probability of the security vulnerability being a false positive.

Embodiments also encompass a computer system for managing security vulnerabilities in software development. The computer system is equipped with one or more processors and non-transitory computer-readable storage media which, when executed by the one or more processors, cause the computer system to initiate a review process for an application workload during development, wherein the review process includes scanning one or more components of the application workload, identify a security vulnerability based on the review process, predict a probability that the security vulnerability is a false positive based on an analysis of one or more characteristics of the security vulnerability and historical data pertaining to one or more similar security vulnerabilities, identify one or more precedent decisions related to a disposition of the one or more similar security vulnerabilities, wherein the one or more precedent decisions are retrieved from a database containing historical responses to security vulnerabilities, and determine whether to apply an automated disposition action for the security vulnerability based on the one or more precedent decisions and the probability of the security vulnerability being a false positive.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a computer system for automated management of security vulnerabilities in software development.

FIG. 2 shows an example server device of the computer system of FIG. 1.

FIG. 3 shows an example method for management of security vulnerabilities within the realm of software development.

FIG. 4 shows an example method for managing security vulnerabilities within a software development lifecycle.

FIG. 5 shows example physical components of the server device of FIG. 2.

### DETAILED DESCRIPTION

This disclosure relates to the automated management of security vulnerabilities in software development.

The disclosed system initiates a review process for application workloads during their development phase, which encompasses scanning various components, such as source code, executables, and configuration files to detect potential security vulnerabilities.

Upon identification, the system assesses the probability of a security vulnerability being a false positive by analyzing its characteristics and comparing it with historical data on similar vulnerabilities.

Further, the system is equipped to identify precedent decisions related to the disposition of similar security vulnerabilities, which are retrieved from a database containing historical responses to such vulnerabilities. Based on these precedent decisions and the assessed probability of the identified vulnerability being a false positive, the system can determine an appropriate automated disposition action for the vulnerability.

The system extends to comparing the identified security vulnerability against known vulnerabilities to ascertain similarities, to enhance speed and precision in vulnerability identification. Artificial intelligence can be employed to predict the likelihood of false positives, with the AI system being trained on historical data related to similar vulnerabilities. In instances where automated disposition is deemed inapplicable, the system allows for manual review and disposition of the vulnerability, contributing to the continuous updating of a disposition repository. This repository, enriched with new precedent decisions, can serve as training data to further refine the AI's performance and accuracy.

Additionally, the system can be equipped to provide feedback on identified vulnerabilities, encompassing details on the nature and severity of each vulnerability, thereby enabling informed decision-making regarding remediation efforts. The scope of the review process covers various components of application workloads, ensuring comprehensive vulnerability detection and management. The automated disposition actions stipulated by the system range from ignoring non-critical vulnerabilities to flagging serious vulnerabilities for further review, making modifications to the application workload to mitigate vulnerabilities, or updating security protocols to prevent future occurrences, thereby ensuring a proactive and efficient approach to securing software development processes.

The disclosed system addresses inherent challenges in computer technology related to security management by streamlining the processes of vulnerability review and disposition. Through the integration of advanced artificial intelligence algorithms trained on a comprehensive dataset of historical responses and precedent decisions, the system offers a refined method for assessing the likelihood of false positives among detected vulnerabilities. This capability improves resource allocation by reducing the focus on benign issues, thereby improving the processing efficiency within the development environment.

Moreover, the system incorporates a mechanism for dynamically updating its disposition repository with new inputs and manual review outcomes, facilitating continuous improvement in the AI model's performance, which represents a specific technical solution to the problem of managing security vulnerabilities.

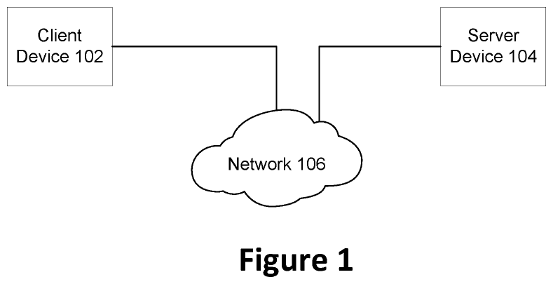

FIG. 1 illustrates a schematic of computer system 100, engineered to automate the management of security vulnerabilities within the software development lifecycle. While the specific embodiments disclosed herein primarily focus on integrating security management within development processes, the fundamental principles demonstrated in FIG. 1 extend beyond this scope. These principles are adaptable, offering improvements in security protocols, threat detection efficiency, and resource optimization across various software development domains and operational frameworks. This versatility allows the system to be effectively implemented in a wide range of software development environments beyond its initial context.

As depicted in FIG. 1, the computer system 100 embodies a computing environment including one or more client devices 102 connected to a server device 104 via a network 106. The one or more client devices 102 can be characterized as computing devices equipped with at least one processor and memory, capable of initiating the security review process and receiving feedback on identified vulnerabilities. The client device 102 can engage in tasks such as code development, vulnerability scanning, and receiving AI-based predictions regarding potential false positives. Exemplifying versatility, the one or more client devices 102 may encompass a range of computing devices including desktop computers, laptops, and integrated development environment systems, or other hardware capable of interfacing with the components of network 106.

The network 106 functions as the underlying communication framework, ensuring seamless data exchange and interaction between the one or more client devices 102 and the server device 104. The server device 104 hosts the AI algorithms and databases necessary for analyzing vulnerabilities, predicting false positives, and determining automated disposition actions based on precedent decisions. This setup facilitates a continuous flow of information, enabling the capability for real-time updates and learning within the system, thereby enhancing the overall efficiency and effectiveness of the security management process within software development projects.

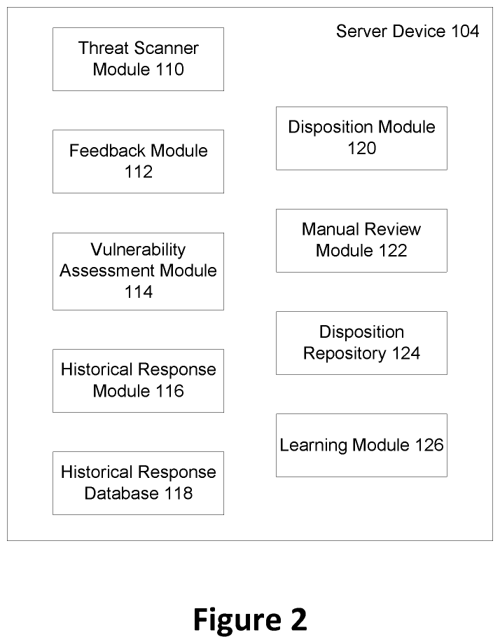

As further depicted in FIG. 2, the server device 104 can comprise one or more modules or engine, with each module configured as a specialized component adapted to perform specific computational processing tasks within the computer system 100. For example, in some embodiments, the server device 104 can include a threat scanner module 110, feedback module 112 vulnerability assessment module 114, historical response module 116, historical response database 118, disposition module 120, manual review module 122, disposition repository 124, and learning module 126. Together, these modules constitute a comprehensive system within the server device 104, enabling the automated management of security vulnerabilities, to reinforce the security infrastructure of software development processes.

The creation of an application workload encompasses the development and compilation of various components essential for the application's functionality and performance. An “Application Workload” refers to the collective set of software elements that are executed to fulfill specific tasks or services within an application. In the financial industry, application workloads may be useful in executing financial transactions, managing customer data, and ensuring regulatory compliance.

Application workloads can include source code, executables or configuration files. Source code comprises the written instructions and commands developed by programmers, which articulate the application's intended functions and operations. Executables are compiled versions of the source code, transformed into machine-readable formats that can be directly executed by the computer's operating system. Configuration files contain settings and parameters that dictate how the application or its components behave under different conditions, allowing for customization and flexibility in application deployment and operation. For example, an application workload within the context of a financial institution might encompass source code developed for processing online payments, executables for running automated trading systems, and configuration files that set parameters for fraud detection algorithms and customer privacy settings.

The development of these components is often facilitated by an “Integrated Development Environment” (IDE), which is a comprehensive software application providing a suite of development tools to computer programmers. An IDE streamlines the software development process by integrating various functionalities such as a source code editor, which allows for the writing and editing of code; build automation tools, which automate tasks like compiling source code into executable programs; and a debugger, which assists in identifying and resolving errors within the code. For example, a developer working on a mobile banking app might use an IDE to write and test code that enables users to transfer funds, check account balances, or deposit checks using their smartphones. The cohesive environment offered by an IDE enhances developer productivity by providing a centralized platform for all aspects of software development, from writing and testing code to debugging and deployment.

“Infrastructure as Code” (IaC) is a paradigm that treats the provisioning and management of computing infrastructure as software development practices, using code to automate the setup and maintenance of hardware components such as servers, networks, and storage systems. IaC allows for infrastructure to be versioned, reused, and shared among development teams, much like application source code. Infrastructure as Code is particularly relevant in the financial industry, and other industries requiring scalable and secure IT infrastructures. By defining infrastructure using code, developers and operations teams can collaborate more effectively, leading to faster and more predictable deployments.

The development of an application workload entails the creation of source code for financial services, compilation into executables for direct execution, and the use of configuration files to tailor application behavior to specific financial processes and compliance standards. This development process, often facilitated by IDEs, is complemented by IaC practices, which automate the provisioning of the necessary infrastructure, ensuring that the applications are supported by a reliable, secure, and compliant computing environment.

The threat scanner module 110 is configured to enhance the security posture of software applications by identifying potential security vulnerabilities early in the development lifecycle. In embodiments, the threat scanner module 110 can be equipped with a suite of features and attributes aimed at comprehensive vulnerability detection and assessment within application workloads, including source code, executables, and configuration files, as well as IaC components.

One of the primary functions of the threat scanner module 110 is to scan for vulnerabilities. The threat scanner module 110 is configured to analyze IaC scripts for misconfigurations, security loopholes, and non-compliance with best practices, ensuring that the infrastructure provisioned for the application is secure from the outset.

The threat scanner module 110 initiates a systematic review process for the application workload during its development phase. In some embodiments, this process involves a scanning of various application components to detect anomalies, patterns, and signatures that may indicate the presence of security vulnerabilities. By integrating this scanning process early in the development cycle, the threat scanner module 110 enables timely identification and remediation of security issues, reducing the risk of vulnerabilities making it into production environments.

Furthermore, the threat scanner module 110 can be designed to integrate with version control systems, facilitating a secure development workflow. As developers push code updates or submit merge requests, the threat scanner module 110 can perform continuous threat scanning of the changes, ensuring that each iteration of the codebase maintains a high security standard to establish a proactive security culture, where vulnerabilities are addressed iteratively as part of the development process rather than retrospectively.

The feedback module 112 is designed to disseminate detailed information regarding identified security vulnerabilities to relevant stakeholders within the software development lifecycle. The feedback module 112 is characterized by its capacity to articulate comprehensive feedback, encapsulating both the nature and severity of detected security vulnerabilities, thereby enabling informed decision-making and timely remediation efforts.

For example, in some embodiments, the feedback module 112 is configured to provide descriptions of identified vulnerabilities, detailing the specific characteristics and behaviors that constitute the security threat, which can include technical explanations of how the vulnerability may be exploited and the potential consequences of such exploitation. In some embodiments, the feedback module 112 is configured to accompany the description of each vulnerability with an assessment of its severity, typically based on standardized scoring systems such as the Common Vulnerability Scoring System (CVSS). This assessment helps prioritize remediation efforts by highlighting vulnerabilities that pose the greatest risk to the application's security.

Beyond identifying vulnerabilities and assessing their severity, the feedback module 112 can offer guidance on remediation strategies, which may include recommended patches, configuration changes, or coding practices to mitigate the identified security issues. Additionally, in some embodiments, the feedback module 112 can provide context around each vulnerability, such as the affected components, the stages of the development process at which the vulnerability was introduced, and any related vulnerabilities that may compound the security risk.

The feedback module 112 operates by aggregating data from the threat scanner module 110 and other relevant components within the server device 104. Upon the identification of a security vulnerability, the feedback module 112 processes this data to generate a comprehensive feedback report. This report can then be communicated to the relevant parties, including developers, security analysts, and automation engineers, through integrated channels such as email notifications, dashboard updates, or direct integration with development and operations tools.

Moreover, integration of the feedback module 112 with version control systems and continuous integration/continuous deployment (CI/CD) pipelines ensures that feedback is delivered in real-time, aligning with the iterative nature of modern software development practices. This continuous feedback loop facilitates a proactive approach to security, where vulnerabilities are addressed promptly and efficiently, reducing the window of exposure and mitigating potential security breaches.

The vulnerability assessment module 114 is configured to evaluate and contextualize security vulnerabilities identified within application workloads. The vulnerability assessment module 114 serves to enhance the precision and relevance of the security management process by providing a deep analysis of each identified vulnerability, its context, and its potential implications.

In some embodiments, the vulnerability assessment module 114 is configured to collect and integrate contextual information regarding the application workload's risk profile, including the operational environment, usage patterns, and criticality of the affected components. This contextual data is associated with each identified vulnerability, thereby enriching the understanding of the threat's potential impact on the system.

The vulnerability assessment module 114 can be equipped with mechanisms to predict the likelihood of an identified security vulnerability being a false positive. This can involve analyzing various characteristics of the vulnerability, such as its signature, location within the codebase, and behavior, in conjunction with historical data on similar vulnerabilities previously encountered within the system or industry. Another attribute of the vulnerability assessment module 114 is its capability to compare detected vulnerabilities against a comprehensive database of known security vulnerabilities. This comparison helps in identifying similarities with previously documented vulnerabilities, aiding in the accurate classification and assessment of the threat.

In some embodiments, the vulnerability assessment module 114 leverages artificial intelligence algorithms to enhance its predictive and analytical capabilities. The AI component can be trained on historical vulnerability data, enabling it to discern patterns and correlations that may not be immediately apparent to human analysts, thereby improving the accuracy of false positive predictions.

Upon the detection of a security vulnerability by the threat scanner module 110, the vulnerability assessment module 114 initiates a detailed review process. This process begins with the gathering of contextual information related to the identified vulnerability, considering factors such as the deployment environment, the criticality of the affected application components, and any relevant user or system behavior patterns.

The vulnerability assessment module 114 then proceeds to analyze the characteristics of the vulnerability, leveraging its AI algorithms to predict the probability of the issue being a false positive. This prediction is informed by a comparison of the vulnerability's attributes with a database of known vulnerabilities, as well as an analysis of historical vulnerability data specific to the system or similar systems.

In some embodiments, the AI component, through continuous learning from historical data and outcomes of previous assessments, refines its predictive models, thereby increasing the reliability and precision of the assessment over time. This learning mechanism allows the module to adapt to evolving threat landscapes and emerging vulnerability patterns.

In essence, the vulnerability assessment module 114 functions as a sophisticated analytical engine within the server device 104, providing a multi-faceted evaluation of security vulnerabilities. By integrating contextual analysis, predictive modeling, comparative analysis, and AI-driven insights, the module significantly contributes to the accurate, informed, and timely management of security threats within the software development lifecycle.

The historical response module 116 is configured to enhance the decision-making process regarding the disposition of identified security vulnerabilities by leveraging past experiences and outcomes. The historical response module 116 plays a role in the system's ability to learn from historical responses and apply this knowledge to current and future security assessments.

In some embodiments, the historical response module 116 is configured to establish a communication link with the historical response database 118. The historical response database 118 serves as a repository of precedent decisions and responses to previously encountered security vulnerabilities. The historical response module 116 can be equipped with mechanisms to query the historical response database 118 and identify precedent decisions that are relevant to the disposition of current vulnerabilities. These precedents can provide insights into effective remediation strategies, mitigation approaches, and risk assessments based on similar past incidents.

Beyond mere retrieval, the historical response module 116 is capable of performing contextual matching to ensure that the precedent decisions identified are pertinent to the specific characteristics and context of the current vulnerability. This can involve analyzing factors such as the vulnerability type, affected components, severity, and the operational environment in which the vulnerability was encountered.

Upon the identification of a security vulnerability by the threat scanner module 110 and subsequent assessment by the vulnerability assessment module 114, the historical response module 116 initiates a query to the historical response database 118. This query is designed to retrieve precedent decisions that bear similarity to the current vulnerability in terms of nature, severity, and context.

The historical response module 116 employs algorithms to sift through the historical response database 118, identifying relevant historical responses that can inform the current disposition decision. This process can involve a detailed comparison of the current vulnerability's attributes with those of vulnerabilities stored in the historical response database 118, ensuring a high degree of relevance and applicability of the retrieved precedents. Once one or more precedent decisions are identified, the historical response module 116 can work with other relevant components within the server device 104 to provide a recommended course of action for the current vulnerability.

The disposition module 120 is configured to automate the decision-making process regarding the management of identified security vulnerabilities. The disposition module 120 synthesizes information from various sources, including precedent decisions and probabilistic analyses of false positives, to determine the most appropriate course of action for each identified vulnerability.

In some embodiments, the disposition module 120 is configured to automate the determination of disposition actions for identified security vulnerabilities. This automation streamlines the vulnerability management process, ensuring timely and consistent responses to potential threats. The disposition module 120 can leverage historical data from the historical response module 116 to inform its decision-making process. By querying for precedent decisions on similar vulnerabilities with comparable risk profiles, the disposition module 120 can ensure that disposition actions are grounded in proven strategies.

In some embodiments the disposition module 120 incorporates probabilistic analysis to assess the likelihood of identified vulnerabilities being false positives. This analysis, potentially enhanced by AI/ML algorithms, can contribute to an ability of the disposition module 120 to prioritize vulnerabilities based on their validity and potential impact.

Upon receiving input from the vulnerability assessment module 114 and the historical response module 116, the disposition module 120 can initiate a comprehensive decision-making process. This process can begin with the disposition module 120 querying the historical response database 118 for precedent decisions that closely match the characteristics and risk profile of the current vulnerability.

Based on the outcome of the historical data query and the false positive analysis, the disposition module 120 can determine an appropriate automated disposition action for the vulnerability. If a significant match with historical precedents is found and the vulnerability is deemed to be a false positive, the module can automatically initiate the chosen disposition action.

The disposition module 120 is capable of executing a variety of automated disposition actions, including but not limited to: ignoring vulnerabilities deemed to be false positives; flagging vulnerabilities for further manual review; initiating modifications to the application workload to mitigate the vulnerability; and updating security protocols to prevent similar vulnerabilities in the future. Additionally, the disposition module 120 make recommendations from simple modifications to the application workload for mitigation, to more comprehensive updates to security protocols to prevent future occurrences of similar vulnerabilities.

In instances where the automated analysis is inconclusive or the vulnerability requires specialized attention, the module may flag the issue for further review by the application team or security experts, providing detailed information on the nature of the vulnerability and recommended next steps.

The manual review module 122 is configured to facilitate the human-driven evaluation and disposition of security vulnerabilities that cannot be adequately addressed through automated processes. The manual review module 122 serves as a juncture where human expertise and judgment are employed to complement and enhance the system's automated capabilities.

In some embodiments, the manual review module 122 can provide a structured interface through which security experts can assess, interact with, and make informed decisions about identified vulnerabilities. This interface is designed to present comprehensive information about each vulnerability, including its nature, context, and the rationale behind its flagging for manual review.

One attribute of the manual review module 122 is its communication with the disposition repository 124, which serves as a dynamic database where decisions and actions taken during manual reviews are recorded and stored as new precedents. Each manual review and subsequent disposition action undertaken through the manual review module 122 contributes to the continuous growth and evolution of the system's disposition repository. By capturing new insights, strategies, and outcomes, the manual review module 122 ensures that the collective wisdom derived from manual reviews is preserved.

When the disposition module 120 encounters a vulnerability that necessitates a nuanced understanding or a specialized approach beyond the scope of automated processes, it redirects the issue to the manual review module 122. This redirection can be triggered by factors such as the complexity of the vulnerability, its potential impact on critical systems, or the ambiguity in its characterization that precludes a clear automated response.

Upon receipt of a vulnerability flagged for manual review, the manual review module 122 presents the issue to designated security experts through its user interface. These experts can be provided with relevant details about the vulnerability, including its detected attributes, the context within which it was identified, and any preliminary assessments made by the automated modules.

The security experts can then undertake a review of the vulnerability, employing their expertise to assess its validity, severity, and potential remediation strategies. This review may involve additional testing, consultation with development teams, or research into similar vulnerabilities and their historical handling.

Once a disposition decision is made, the manual review module 122 facilitates the recording of this decision, along with any associated actions or remediation steps, into the disposition repository 124. This action not only resolves the current vulnerability but also enriches the system's knowledge base, ensuring that similar future vulnerabilities can benefit from the insights gained during the manual review process.

The learning module 126 within the server device 104 can be configured to continuously refine and enhance the system's decision-making algorithms, particularly those driven by AI. The learning module 126 can aid in ensuring that the system's AI models evolve in accuracy and performance over time, adapting to new data and insights derived from the system's operational experiences.

One feature of the learning module 126 is its capability to leverage data from the disposition repository 124 as training material for AI models. The disposition repository 124, enriched with precedent decisions and outcomes from both automated and manual vulnerability dispositions, provides a dataset that reflects real-world scenarios and decision-making processes. The learning module 126 is designed to integrate decisions made by security experts during manual reviews into the training data for AI models. This incorporation ensures that the nuanced judgments and expertise of human security professionals augment the learning of AI algorithms, enhancing the system's overall intelligence and adaptability.

The learning module 126 also facilitates the update of the historical response database 118 with new precedent decisions, especially those associated with false positives. By recording and learning from instances where vulnerabilities were incorrectly identified or overemphasized, the AI models can improve their discernment, reducing the likelihood of future false positives.

The learning module 126 operates by systematically analyzing the outcomes and decisions stored within the disposition repository 124. This analysis involves extracting patterns, decision logic, and outcomes from the repository data, which are then used to train and refine the AI models responsible for vulnerability assessment, prediction, and disposition.

When the system encounters a vulnerability for which no relevant precedent exists, the learning module 126 can trigger the involvement of a security expert for manual review. The expert's assessment and disposition decision are recorded and then fed back into the learning module 126. This feedback loop not only resolves the immediate vulnerability but also serves as a new data point for training the AI models, thereby enhancing the system's future responses to similar vulnerabilities.

In cases where a vulnerability is determined to be a false positive, the learning module 126 can update the historical response database 118 with this new precedent, for the continuous improvement of the AI models, enabling them to better distinguish between genuine vulnerabilities and benign anomalies in future assessments.

With many of the processes automated based on precedent decisions, system 100 is architected to exhibit scalability and adaptability, qualities that are important in accommodating the swift evolution characteristic of contemporary application architectures. This adaptability is of paramount significance in the current landscape of software development, which is increasingly dominated by the adoption of microservices architectures, the pervasive use of cloud-native technologies, and the practice of implementing frequent updates to applications.

Microservices architectures, by design, promote the development of applications as a collection of loosely coupled services, each encapsulating a specific business functionality. This approach enhances modularity but also introduces complexity in terms of security management, as each service potentially represents a unique attack vector. The system 100, with its modular design, is well-suited to address these complexities by providing targeted vulnerability assessments and responses tailored to the distinct characteristics of each microservice.

Similarly, the embrace of cloud-native technologies, which are designed to exploit the benefits of cloud computing delivery models, necessitates a security management system that is both flexible and robust, enabling the system 100 to integrate seamlessly with cloud-based infrastructures and services ensures that security management processes remain effective and efficient, regardless of the underlying cloud technology stack.

Furthermore, the trend towards more frequent updates, driven by methodologies such as Agile and DevOps, demands a security management system that can keep pace with rapid deployment cycles. The system 100 addresses this need through automation and continuous learning capabilities, enabling real-time vulnerability assessments and dispositions that align with the iterative nature of modern software development and deployment practices.

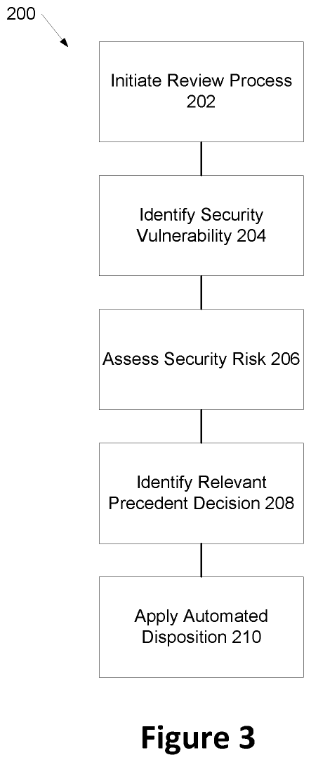

Referring to FIG. 3, a flowchart depicting a method 200 for the management of security vulnerabilities is depicted in accordance with an embodiment of the disclosure. The method 200 encapsulates a series of steps designed to identify, assess, and address security vulnerabilities effectively, leveraging both historical data and predictive analyses.

At step 202, the method 200 can commence with the initiation of a review process for an application workload that is currently under development. This initial phase encompasses a scanning of various components within the application workload, such as source code, executables, and configuration files, aiming to uncover potential security vulnerabilities at an early stage of the software development lifecycle.

Proceeding to step 204, the method 200 can involve the identification of security vulnerabilities that emerge from the review process initiated in step 202. Accordingly, step 204 can serve to establish a foundation for subsequent analyses and decision-making processes by pinpointing specific vulnerabilities that warrant further investigation and potential remediation.

At step 206, the method 200 can advance to the assessment of the security risk associated with each identified vulnerability. The assessment can include analysis aimed at predicting the likelihood of the identified security vulnerability being a false positive. Such predictions are informed by examining various characteristics of the security vulnerability in question, alongside historical data concerning similar security vulnerabilities previously encountered. This predictive assessment aids in prioritizing vulnerabilities based on their potential impact and authenticity.

In step 208, the method 200 entails identifying one or more precedent decisions that pertain to the disposition of vulnerabilities similar to those identified in step 204. These precedent decisions can be retrieved from a dedicated database that archives historical responses to security vulnerabilities. By consulting this repository of historical data, the method 200 leverages past experiences and resolutions to inform the current decision-making process.

At step 210, the method 200 culminates in determining the appropriate automated disposition action for each identified security vulnerability. This determination is based on a synthesis of the insights gained from the precedent decisions identified in step 208 and the probabilistic assessment conducted in step 206. The selected disposition action may vary, ranging from ignoring the vulnerability if deemed a false positive to more proactive measures such as modification of the application workload or updating security protocols, contingent upon the evaluated risk and historical precedents.

Overall, method 200 encapsulates a comprehensive methodological approach to managing security vulnerabilities in software development, emphasizing the importance of early detection, rigorous assessment, and informed decision-making grounded in historical insights and predictive analytics.

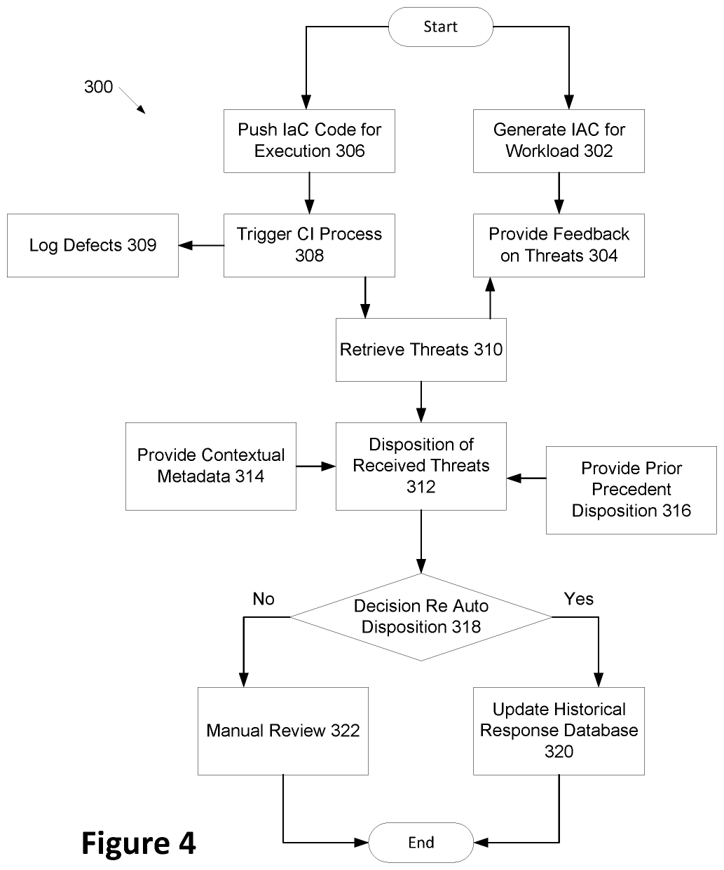

FIG. 4 illustrates a method 300, which outlines a sequence of steps and decision points involved in the process of managing security vulnerabilities within the software development lifecycle. FIG. 4 provides a visual representation of the procedural flow, starting from the generation of IaC for the application workload, through to the potential manual review of identified threats, emphasizing the systematic and interconnected nature of the process.

At step 302, the method 300 initiates with the generation of IaC for workload on IDE, where developers use an integrated development environment to create and configure IaC scripts. These scripts define the infrastructure setup for the application workload, laying the foundation for subsequent operations.

Proceeding to step 304, the method 300 provides for feedback on threats on IDE. For example, in one embodiment, the system analyzes the generated IaC scripts within the IDE to identify potential security threats. In some cases, feedback can be provided to developers, allowing for the early detection and remediation of vulnerabilities within the IaC.

At step 306, the IaC scripts, having been reviewed and potentially modified based on the feedback received, are committed to a version control system. This step marks the transition of IaC scripts from development to deployment preparation. Step 308 involves the initiation of a continuous integration process, which automatically builds and tests the IaC scripts to ensure their integrity and readiness for deployment.

In step 309, any defects or vulnerabilities identified during the CI process can be logged for further analysis. This step ensures that all potential threats are captured and made available for detailed assessment. At step 310, the system retrieves the logged defects for a review, preparing them for the disposition process.

Step 312 involves the evaluation and determination of appropriate actions for the retrieved threats, based on their nature and severity. In step 314, the system enriches the threat data with contextual metadata, enhancing the understanding of each threat's potential impact and aiding in the decision-making process. Step 316 entails the retrieval of precedent dispositions from a historical response database. This step leverages past experiences to inform the disposition of current threats.

At step 318, a decision is made regarding the automation of the disposition action for each threat, considering the provided contextual metadata and precedent dispositions. Step 320, involves updating the historical response database with new dispositions, ensuring that the system's knowledge base continues to evolve and improve over time. At, step 322, threats that require further examination or that cannot be adequately addressed through automated processes are escalated for manual review by security experts. This step ensures that complex or ambiguous threats receive the detailed attention necessary for effective resolution.

The method 300 delineates a comprehensive workflow for managing security vulnerabilities in software development. From the initial generation of IaC in an IDE to the potential manual review of threats, each step is designed to ensure thorough detection, assessment, and resolution of security vulnerabilities, contributing to the overall security and integrity of the software development process.

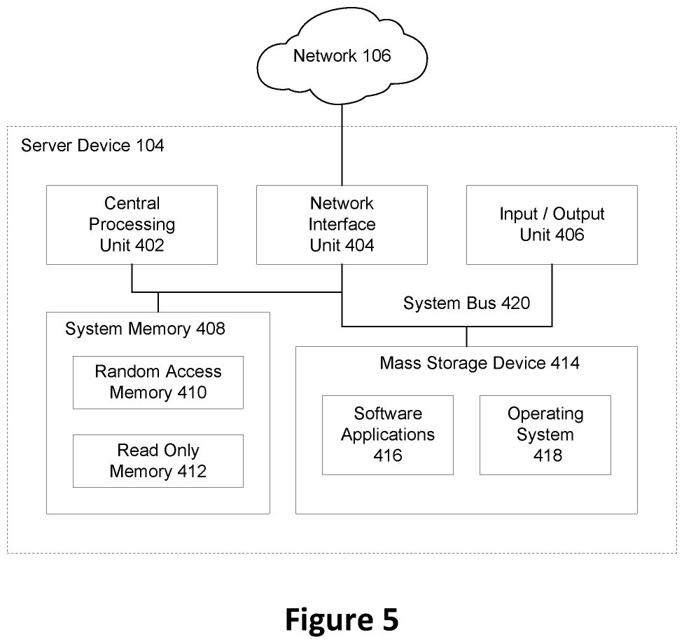

As illustrated in the embodiment of FIG. 5, the example server device 104, which provides the functionality described herein, can include at least one central processing unit (“CPU”) 402, a system memory 408, and a system bus 420 that couples the system memory 408 to the CPU 402. The system memory 408 includes a random access memory (“RAM”) 410 and a read-only memory (“ROM”) 612. A basic input/output system containing the basic routines that help transfer information between elements within the system 100, such as during startup, is stored in the ROM 412. The system 100 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 420. The mass storage device 414 and its associated computer-readable data storage media provide non-volatile, non-transitory storage for the system 100. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 104.

According to various embodiments of the invention, the system 100 may operate in a networked environment using logical connections to remote network devices through network 108, such as a wireless network, the Internet, or another type of network. The network 108 provides a wired and/or wireless connection. In some examples, the network 108 can be a local area network, a wide area network, the Internet, or a mixture thereof. Many different communication protocols can be used.

The server device 104 may connect to network 108 through a network interface unit 404 connected to the system bus 420. It should be appreciated that the network interface unit 404 may also be utilized to connect to other types of networks and remote computing systems. The server device 104 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 104 can store software instructions and data. The software instructions include an operating system 418 suitable for controlling the operation of the server device 104. The mass storage device 414 and/or the RAM 410 also store software instructions and applications 416, that when executed by the CPU 402, cause the server device 104 to provide the functionality of the computer system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for managing security vulnerabilities in software development, comprising:
initiating a review process for an application workload during development, wherein the review process includes scanning one or more components of the application workload;
identifying a security vulnerability based on the review process;
predicting a probability that the security vulnerability is a false positive based on an analysis of one or more characteristics of the security vulnerability and historical data pertaining to one or more similar security vulnerabilities;
identifying one or more precedent decisions related to a disposition of the one or more similar security vulnerabilities, wherein the one or more precedent decisions are retrieved from a database containing historical responses to security vulnerabilities; and
determining whether to apply an automated disposition action for the security vulnerability based on the one or more precedent decisions and the probability of the security vulnerability being a false positive.

2. The method of claim 1, further comprising comparing aspects of the security vulnerability to known security vulnerabilities to identify the one or more similar security vulnerabilities.

3. The method of claim 1, wherein predicting the probability that the security vulnerability is a false positive includes the use of artificial intelligence.

4. The method of claim 3, wherein the artificial intelligence is trained using the historical data pertaining to the one or more similar security vulnerabilities.

5. The method of claim 1, further comprising manually reviewing and disposing of the security vulnerability where it is determined not to apply the automated disposition action.

6. The method of claim 5, wherein manually reviewing contributes to updating a disposition repository, including new precedent decisions regarding potential security vulnerabilities.

7. The method of claim 6, wherein the disposition repository is used as training data to enhance a performance and accuracy of artificial intelligence.

8. The method of claim 1, further comprising providing feedback regarding the security vulnerability, wherein the feedback includes information about a nature and severity of the security vulnerability.

9. The method of claim 1, wherein the one or more components of the application workload include source code, executables, or configuration files.

10. The method of claim 1, wherein the automated disposition action includes at least one of ignoring the security vulnerability, flagging the security vulnerability for further review, modifying the application workload, or updating security protocols.

11. A computer system for managing security vulnerabilities in software development, comprising:
one or more processors; and
non-transitory computer-readable storage media encoding instructions which, when executed by the one or more processors, cause the computer system to:
initiate a review process for an application workload during development, wherein the review process includes scanning one or more components of the application workload;
identify a security vulnerability based on the review process;
predict a probability that the security vulnerability is a false positive based on an analysis of one or more characteristics of the security vulnerability and historical data pertaining to one or more similar security vulnerabilities;
identify one or more precedent decisions related to a disposition of the one or more similar security vulnerabilities, wherein the one or more precedent decisions are retrieved from a database containing historical responses to security vulnerabilities; and
determine whether to apply an automated disposition action for the security vulnerability based on the one or more precedent decisions and the probability of the security vulnerability being a false positive.

12. The computer system of claim 11, wherein the instructions further cause the computer system to compare aspects of the security vulnerability to known security vulnerabilities to identify the one or more similar security vulnerabilities.

13. The computer system of claim 11, wherein predicting the probability that the security vulnerability is a false positive includes the use of artificial intelligence.

14. The computer system of claim 13, wherein the artificial intelligence is trained using the historical data pertaining to the one or more similar security vulnerabilities.

15. The computer system of claim 11, wherein the instructions further cause the computer system to manually review and dispose of the security vulnerability where it is determined not to apply the automated disposition action.

16. The computer system of claim 15, wherein manually reviewing contributes to updating a disposition repository, including new precedent decisions regarding potential security vulnerabilities.

17. The computer system of claim 16, wherein the disposition repository is used as training data to enhance a performance and accuracy of artificial intelligence.

18. The computer system of claim 11, wherein the instructions further cause the computer system to provide feedback regarding the security vulnerability, including information about a nature and severity of the security vulnerability.

19. The computer system of claim 11, wherein the one or more components of the application workload include source code, executables, or configuration files.

20. The computer system of claim 11, wherein the automated disposition action includes at least one of ignoring the security vulnerability, flagging the security vulnerability for further review, modifying the application workload, or updating security protocols.
